(19) United States
(12) Patent Application Publication
(10) Pub. No.: US 2019/0265583 A1
(43) Pub. Date: Aug. 29, 2019

(54) LIGHT SOURCE DEVICE, ILLUMINATION APPARATUS, AND PROJECTOR APPARATUS

(71) Applicant: SHARP KABUSHIKI KAISHA, Sakai City (JP)

(72) Inventors: KOJI TAKAHASHI, Sakai City (JP); HIDENORI KAWANISHI, Sakai City (JP); KARL PETER WELNA, Oxford (GB)

(21) Appl. No.: 16/279,324

(22) Filed: Feb. 19, 2019

(30) Foreign Application Priority Data
Feb. 23, 2018 (JP) 2018-030533

(51) Int. Cl. G03B 21/20

(52) U.S. Cl. CPC G03B 21/204; F21S 41/176

(57) ABSTRACT

A light source device includes a laser device emitting primary light, a wavelength converter including an illuminated region to which the primary light is applied, and performing wavelength conversion from the primary light to secondary light, and a light output portion through which the secondary light is taken out, wherein an area of the illuminated region is larger than an area of the light output portion, and the area of the light output portion is not larger than 7 mm².

### BACKGROUND

### 1. Field

The present disclosure relates to a light source device, an illumination apparatus, and a projector apparatus in each of which primary light emitted from a laser device is wavelength-converted to secondary light by a wavelength converter.

### 2. Description of the Related Art

A technique of obtaining a white or monochromatic high-luminance light source by exciting a phosphor with primary light emitted from a blue semiconductor laser, and by causing the phosphor to emit secondary light has been developed in recent years. The white light source is commercialized as a laser headlight, and floodlight capable of reaching up to a farther position than light of a LED (Light Emitting Diode) is realized with optical design utilizing the high-luminance light source. Regarding the laser headlight using the above-described technique, a flood lamp can be designed if the white light source on the order of several hundreds to 2000 lumens is realized.

The monochromatic high-luminance light source using the analogous technique is commercialized as a light source device for a projector. A projector capable of outputting high luminous flux that is not obtained with the LED is realized by using a laser as a light source instead of a mercury lamp. In the projector using the above technique, a light source device on the order of several thousands to several ten thousands lumens far above a level of the laser headlight is demanded.

With the above-described light source device using the laser and the phosphor, the high-luminance light source incapable of being realized with the LED can be obtained in both application fields as the headlight and the projector by condensing laser light in the form of a smaller spot on the phosphor to perform wavelength conversion. In other words, the high-luminance light source is a light source capable of obtaining large luminous flux (luminous intensity) from a small area, and an area of a light output portion is to be small.

However, when the laser light is condensed to the small spot on the phosphor, heating of the phosphor is escalated. In the light source on the order of several hundreds to 2000 lumens used in the laser headlight, heat dissipation can be effectuated by properly designing a phosphor light-emitting portion, but it is difficult to effectuate the heat dissipation from the phosphor light-emitting portion in the light source on the order of several thousands to several ten thousands lumens demanded in the projector. In consideration of the above, there is proposed a technique of using a wheel-shaped wavelength converter, rotating the wavelength converter by a motor to change a laser-light illuminated region with rotation of the wavelength converter, and distributing heat generated from the wavelength converter without concentrating the heat on one point (see, for example, Japanese Unexamined Patent Application Publication No. 2010-237443)

In the above-described related art, however, because of mechanically rotating the wavelength converter by the motor, etc. to illuminate only part of the wavelength converter with the laser light (primary light), and of employing a control circuit for controlling the rotation of the motor, etc. and a device for transmitting motive power, a difficulty arises in reducing the size and the weight of the light source device. Furthermore, if any trouble occurs in a rotation mechanism including the motor, etc., there is a possibility that the rotation of the wavelength converter is stopped, heat dissipation from the laser-light illuminated region in the wavelength converter is impeded, and the wavelength converter is deteriorated or damaged.

On the other hand, when the rotation mechanism including the motor, etc. is not used, deterioration or damage of the wavelength converter is to be avoided by suppressing a temperature rise in the laser-light illuminated region, and a limitation arises in increasing the intensity of the laser light applied for illumination.

It is hence desirable to provide a light source device, an illumination apparatus, and a projector apparatus in each of which a higher luminance and a smaller size can be realized while a structure is simplified without using a rotation mechanism.

### SUMMARY

According to one aspect of the disclosure, there is provided a light source device including a laser device emitting primary light, a wavelength converter including an illuminated region to which the primary light is applied, and performing wavelength conversion from the primary light to secondary light, and a light output portion through which the secondary light is taken out, wherein an area of the illuminated region is larger than an area of the light output portion, and the area of the light output portion is not larger than 7 mm².

An illumination apparatus including the light source device according to the one aspect of the disclosure is also provided.

A projector apparatus including the light source device according to the one aspect of the disclosure is further provided.

According to another aspect of the disclosure, there is provided a light source device including a laser device emitting primary light, a wavelength converter including an illuminated region to which the primary light is applied, and performing wavelength conversion from the primary light to secondary light, and a light output portion through which the secondary light is taken out, wherein an area of the illuminated region is larger than an area of the light output portion, and a luminance of the secondary light in the light output portion is not lower than 1000 Mcd/m².

An illumination apparatus including the light source device according to the other aspect of the disclosure is also provided.

A projector apparatus including the light source device according to the other aspect of the disclosure is further provided.

### BRIEF DESCRIPTION OF THE DRAWINGS

FIGS. 1A and 1B are block diagrams illustrating configurations of apparatuses each using a light source device according to a first embodiment; specifically, FIG. 1A represents an example in which the light source device is applied to an illumination apparatus, and FIG. 1B represents an example in which the light source device is applied to a projector apparatus;

FIG. 2 is a schematic sectional view illustrating a structure of the light source device according to the first embodiment;

FIGS. 3A and 3B are schematic sectional views illustrating modifications of the first embodiment; specifically, FIG. 3A represents an example in which a wavelength converter has a substantially truncated cone shape with a smaller diameter on the side including a light output portion, and FIG. 3B represents an example in which the wavelength converter has a substantially truncated cone shape with a larger diameter on the side including the light output portion;

FIGS. 4A and 4B illustrate a light source device according to a second embodiment; specifically, FIG. 4A is a schematic sectional view, and FIG. 4B is a plan view of a laser unit;

FIGS. 5A, 5B, 5C and 5D illustrate a light source device according to a third embodiment; specifically, FIG. 5A represents an example in which a phosphor layer is formed on an inner surface of a recess in a heat dissipator, FIG. 5B represents an example in which an area of the light output portion is reduced, FIG. 5C represents an example in which the recess has a wide bottom, and FIG. 5D represents an example in which the recess has a substantially spherical shape;

FIG. 6 is a schematic sectional view illustrating a light source device according to a fourth embodiment;

FIGS. 7A, 7B and 7C are schematic sectional views illustrating modifications of the fourth embodiment; specifically, FIG. 7A represents an example in which the phosphor layer is formed on a surface of a transparent member, FIG. 7B represents an example in which the phosphor layer is formed on the inner surface of the recess in the heat dissipator and the transparent member is filled in the recess, and FIG. 7C represents an example in which the phosphor layer is formed on a surface of part of the transparent member;

FIGS. 8A and 8B are schematic sectional views each illustrating a light source device according to a fifth embodiment; specifically, FIG. 8A represents an example in which the wavelength converter has a substantially semispherical shape, and FIG. 8B represents an example in which the wavelength converter has a substantially parabolic shape;

FIG. 9 is a schematic sectional view illustrating a structure of a light source device according to a sixth embodiment; and

FIGS. 10A and 10B are schematic sectional views illustrating modifications of the sixth embodiment; specifically, FIG. 10A represents an example in which the wavelength converter has a substantially truncated cone shape with a smaller diameter on the side including the light output portion, and FIG. 10B represents an example in which the wavelength converter has a substantially truncated cone shape with a larger diameter on the side including the light output portion.

### DESCRIPTION OF THE EMBODIMENTS

### First Embodiment

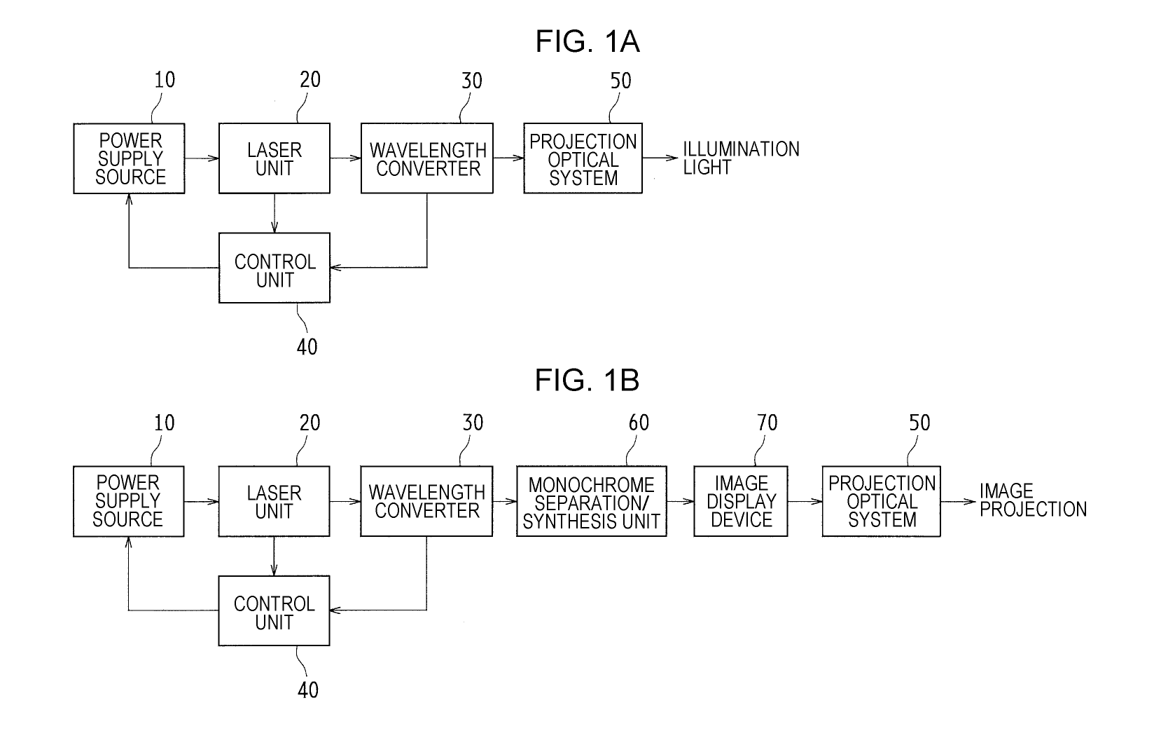

Embodiments of the present disclosure will be described in detail below with reference to the drawings. In this specification and the drawings, components having substantially the same functions are denoted by the same reference signs, and duplicate description of those components is omitted. FIGS. 1A and 1B are block diagrams illustrating configurations of apparatuses each using a light source device according to a first embodiment; specifically, FIG. 1A represents an example in which the light source device is applied to an illumination apparatus, and FIG. 1B represents an example in which the light source device is applied to a projector apparatus.

The illumination apparatus illustrated in FIG. 1A includes a power supply source 10, a laser unit 20, a wavelength converter 30, a control unit 40, and a projection optical system 50.

The power supply source 10 supplies electric power having a current value and a voltage value, which are demanded to effectuate light emission in the laser unit 20, to the laser unit 20 in accordance with a control signal from the control unit 40. For example, a primary battery, a secondary battery, or a commercial power supply can be used as the power supply source 10. The power supply source 10 includes circuits such as a voltage conversion circuit and a rectifier circuit.

The laser unit 20 emits primary light of a predetermined wavelength through laser oscillation upon supply of the electric power from the power supply source 10, and illuminates the wavelength converter 30 with the primary light. The laser unit 20 further measures a light-emitting state and transmits a measurement result to the control unit 40. A wavelength of the primary light emitted from the laser unit 20 is not limited to a particular value, and a known laser device emitting blue light, violet light, or near-ultraviolet light, for example, can be used depending on an absorption band of the wavelength converter 30.

The wavelength converter 30 is a member containing a phosphor material, and it wavelength-converts the primary light from the laser unit 20 to the secondary light and illuminates the projection optical system 50 with the secondary light. The phosphor material contained in the wavelength converter 30 is not limited to particular one. When the primary light is blue, a known phosphor material emitting yellow light as the secondary light, such as a YAG phosphor, may be used, and white light obtained with color mixing of the primary light and the secondary light may be used for the illumination. When the primary light is violet light or near-ultraviolet light, known phosphor materials emitting blue, red and green lights as the secondary lights may be used, and white light obtained with color mixing of the secondary lights may be used for the illumination.

The control unit 40 is an information processing device that controls an output of the power supply source 10 depending on the light-emitting state of the laser unit 20, a predetermined quantity of light, and so on. Control performed by the control unit 40 is not limited to a particular method, and may be a combination of known laser control methods, such as APC (Automatic Power Control) and PWM (Pulse Width Modulation) control.

The projection optical system 50 is a combination of optical members for guiding light to the outside, and it may be constituted using, for example, a reflective mirror, a lens, etc. When the illumination apparatus is a vehicle lamp such as a headlamp, the projection optical system 50 may include such mechanisms as for switching over a high beam and a low beam, and controlling a luminous intensity distribution.

In the illumination apparatus illustrated in FIG. 1A, the laser unit 20 emits the primary light with the electric power supplied from the power supply source 10, the primary light applied to the wavelength converter 30 is converted to the secondary light, and both the primary light and the secondary light are taken out to the outside through the projection optical system 50 for illumination with white light.

The projector apparatus illustrated in FIG. 1B includes the power supply source 10, the laser unit 20, the wavelength converter 30, the control unit 40, the projection optical system 50, a monochrome separation/synthesis unit 60, and an image display device 70. In the case of the projector apparatus, the wavelength converter 30 is prepared for each of red, green and blue colors, and the image display device 70 is illuminated with light obtained after having been synthesized or separated by the monochrome separation/synthesis unit 60. Then, an image is projected to the outside through the projection optical system 50.

The monochrome separation/synthesis unit 60 is an optical element that synthesizes or separates light using a half mirror or a dichroic mirror. The image display device 70 is a device for controlling a reflection direction of pixel light in accordance with an image signal, and is constituted by, for example, a DMD (digital Micromirror Device). Although this embodiment represents an example in which the secondary light obtained from the wavelength converter 30 through the monochrome separation/synthesis unit 60 is incident on the image display device 70, the image display device 70 may be first illuminated with the secondary light, and light from the image display device 70 may be guided to the outside through the monochrome separation/synthesis unit 60 and the projection optical system 50 for image illumination.

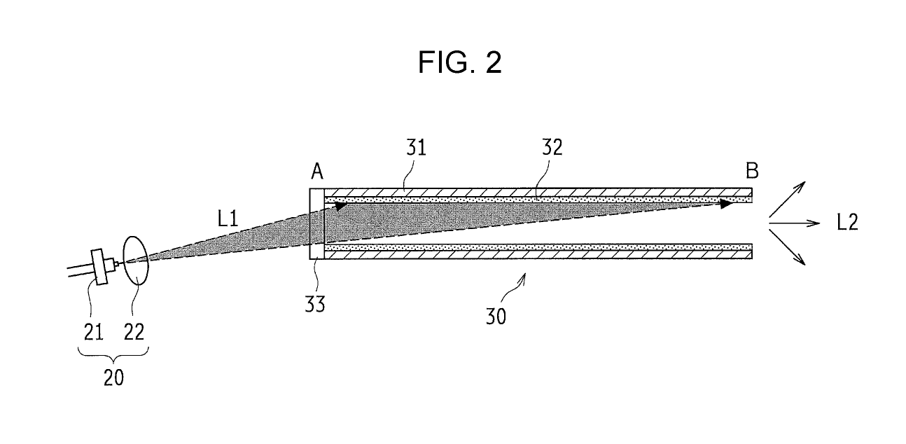

FIG. 2 is a schematic sectional view illustrating a structure of the light source device according to this embodiment. In the light source device according to this embodiment, the laser unit 20 includes a laser device 21 and a lens 22, and the wavelength converter 30 includes a heat dissipator 31, a phosphor layer 32, and a wavelength filter 33. Although FIG. 2 illustrates an example in which one laser unit 20 is used, primary lights L1 may be applied to different regions of the phosphor layer 32 by using plural laser units 20.

The laser device 21 includes a semiconductor laser that emits the primary light L1 through laser oscillation upon supply of electric power. A wavelength of the primary light L1 is not limited to a particular value, and a laser oscillating in blue light of a wavelength of about 450 nm, for example, can be used. Although FIG. 2 illustrates the laser device 21 in CAN package, a shape and a size of the package are not limited to particular ones. The laser device 21 may have a known structure and may be of the resin encapsulated type or the open type.

The lens 22 is an optical element for controlling an intensity distribution of the primary light L1 emitted from the laser device 21 and guiding the primary light L1 so as to enter the wavelength converter 30. The lens 22 of the type enlarging a beam size of the primary light L1 is advantageously used from the viewpoint of, as described later, increasing an area of an illuminated region in the wavelength converter 30, which is illuminated with the primary light.

The heat dissipator 31 is a member for not only holding the phosphor layer 32, but also dissipating heat generated from the phosphor layer 32 to the outside. Although the material of the heat dissipator 31 is not limited to particular one, it is advantageous that the material has good thermal conductivity and adequate rigidity. Thus, the heat dissipator 31 is advantageously made of a metal such as aluminum or copper. In particular, because the phosphor layer 32 is formed on an inner surface of the heat dissipator 31, aluminum capable of efficiently reflecting both the primary light L1 and the secondary light L2 is advantageously used. Alternatively, a film having a high reflectance, such as an aluminum or silver film, may be coated over an inner surface of a metal having high thermal conductivity, such as copper.

The heat dissipator 31 in this embodiment, illustrated in FIG. 2, has a substantially circular cylindrical shape and is made of aluminum. One end portion of the heat dissipator 31 is used as a light input portion A, and the other end portion is used as a light output portion B. The wavelength filter 33 is arranged in the light input portion A. Although the heat dissipator 31 having the substantially circular cylindrical shape is illustrated here, the heat dissipator 31 may have a cross-sectional shape other than a circle, and the cross-sectional shape may be rectangular or polygonal, for example. Furthermore, the heat dissipator 31 may include a known heat dissipation structure of, for example, the air-cooling or water-cooling type using heat dissipation fins or a fan disposed around the heat dissipator 31, or the heat-transport or heat-diffusion type using heat pipes.

The phosphor layer 32 is formed on the inner surface of the heat dissipator 31, and contains a phosphor material that is illuminated with the primary light L1 and emits the secondary light L2 after wavelength conversion of part of the primary light L1. A type of the phosphor material contained in the phosphor layer 32 is not limited to particular one, and the phosphor material can be appropriately selected from among known materials absorbing the primary light L1 and emitting the secondary light L2. For example, a YAG-based phosphor excited by blue light and emitting yellow light can be used. The phosphor layer 32 contains a large number of phosphor particles obtained by pulverizing the phosphor material into fine particles. The form of the phosphor particles contained in the phosphor layer 32 is not limited to particular one, and the phosphor particles may be dispersed in resin or glass, or may be contained in a state that the phosphor particles transparent fine particles contact with each other.

From the viewpoint of efficiently transmitting heat generated in the phosphor layer 32 to the heat dissipator 31, the phosphor layer 32 is advantageously formed such that the large number of phosphor particles are held in a substantially contacted state. Here, the wording “phosphor particles are held in a substantially contacted state” implies the case that the adjacent phosphor particles are directly contacted with each other, or the case that transparent fine particles of SiO₂ or TiO₂, for example, are filled as binders in gaps between the phosphor particles.

The wavelength filter 33 is a bandpass filter that is disposed in the light input portion A of the heat dissipator 31, and that allows the primary light L1 to pass therethrough, but reflects light of wavelengths other than the wavelength of the primary light L1. Because the wavelength filter 33 is disposed in the light input portion A to take the primary light L1 into the wavelength converter 30 through the wavelength filter 33, the secondary light L2 is avoided from exiting to the outside from the side including the light input portion A.

In the light source device according to this embodiment illustrated in FIG. 2, the beam size of the primary light L1 emitted from the laser device 21 is enlarged through the lens 22 and is almost uniformly applied to the phosphor layer 32 after passing through the wavelength filter 33. At that time, optical axes of both the laser device 21 and the primary light L1 are inclined relative to a central axis of the substantially circular cylindrical shape of the heat dissipator 31, and the primary light L1 is applied to a wide region of the phosphor layer 32 formed on the inner surface of the heat dissipator 31. Assuming that a region of the phosphor layer 32 to which the primary light L1 is directly applied from the laser device 21 is called an “illuminated region”, the illuminated region spans over substantially an entire length of the inner surface of the heat dissipator 31 in one half of the substantially circular cylindrical shape.

Part of the primary light L1 is wavelength-converted to the secondary light L2 in the illuminated region of the phosphor layer 32, and the primary light L1 having not been subjected to the wavelength conversion and the secondary light L2 are both output to the outside for illumination from the light output portion B after having been reflected by the inner surface of the heat dissipator 31 and the phosphor layer 32. Accordingly, a direction of a normal line to a principal surface of the illuminated region of the phosphor layer 32 is different from an outgoing direction of the white light from the light output portion B, and those directions are substantially perpendicular to each other. Thus, by separately setting the illuminated region where the primary light L1 is wavelength-converted to the secondary light L2 and the light output portion B from each other, an area of the light output portion B can be reduced while the area of the illuminated region can be enlarged and a larger quantity of light can be emitted.

For instance, when the secondary light L2 in a broad wavelength range having a peak in a yellow color is obtained by using, as the laser device 21, a GaN laser oscillating in blue light of a wavelength of about 450 nm, and by using, as the phosphor layer 32, YAG-based phosphor particles, white light resulting from color mixing of the primary light L1 and the secondary light L2 is output to the outside for illumination from the light output portion B. The phosphor particles contained in the phosphor layer 32 have an average particle size (D50) of about 5 μm, for example, and they are coated in an average layer thickness of about 12 μm over the inner surface of the heat dissipator 31. The heat dissipator 31 has the substantially circular cylindrical shape having an inner circumference with a diameter of about 2 mm and an overall length of about 10 mm. The area of the illuminated region is about 30 mm², and the cross-sectional area of the light output portion B is about 3 mm². This embodiment represents, as an example of using the light source device in the illumination apparatus, the case that the white light is output. However, when the light source device is used in the projector, monochromatic lights in red, green and blue may be output to the outside for illumination from the light output portion.

By setting the area of the illuminated region of the phosphor layer 32 to be larger than that of the light output portion B as described above, heat generated in the illuminated region with the wavelength conversion is effectively transmitted to the heat dissipator 31 and dissipated to the outside of the light source device. Accordingly, even when a quantity of the primary light L1 emitted from the laser device 21 is increased, a temperature rise in the illuminated region of the phosphor layer 32 can be suppressed, deterioration and damage of the phosphor layer 32 can be avoided, and the white light of 40000 lumens can be output from the light output portion B in intensity distribution analogous to the Lambertian distribution. Furthermore, since the white light is taken out from the light output portion B having the cross-sectional area of not larger than 7 mm², the luminance in the light output portion B corresponds to about 4000 Mcd/m², i.e., a high luminance of not lower than 1000 Mcd/m². As a result, in the light source device according to this embodiment, a higher luminance and a smaller size can be realized while the structure is simplified without using a rotation mechanism.

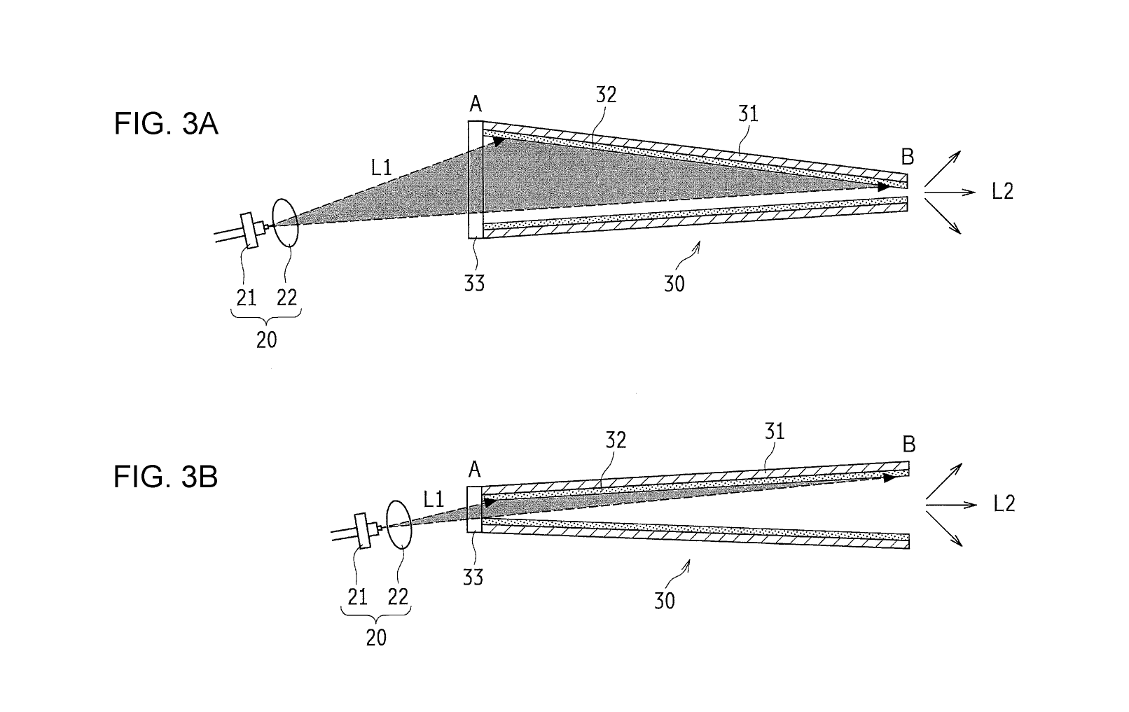

FIGS. 3A and 3B are schematic sectional views illustrating modifications of the first embodiment; specifically, FIG. 3A represents an example in which the wavelength converter has a substantially truncated cone shape with a smaller diameter on the side including the light output portion B, and FIG. 3B represents an example in which the wavelength converter has a substantially truncated cone shape with a larger diameter on the side including the light output portion B. As illustrated in FIGS. 3A and 3B, an inner diameter of the heat dissipator 31 and the phosphor layer 32 may not be constant from the light input portion A to the light output portion B, and the wavelength converter 30 may have a substantially truncated cone shape with an inner diameter gradually decreasing or increasing. In the modification illustrated in FIG. 3A, the cross-sectional area of the light input portion A is increased to make the wavelength converter 30 more easily illuminated with the primary light L1, and the cross-sectional area of the light output portion B is reduced to increase the luminance. In the modification illustrated in FIG. 3B, the inner diameter is gradually increased toward the light output portion B. Therefore, the primary light L1 and the secondary light L2 can be effectively reflected toward the light output portion B, and the light output efficiency can be increased.

### Second Embodiment

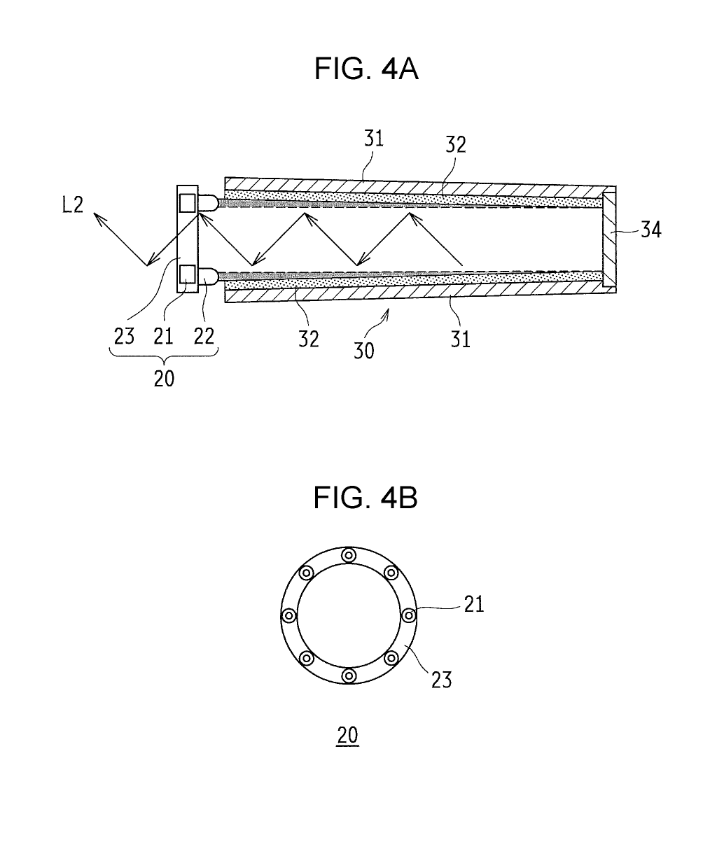

A second embodiment of the present disclosure will be described below with reference to the drawings. Description of components similar to those in the first embodiment is omitted. FIGS. 4A and 4B illustrate a light source device according to this embodiment; specifically, FIG. 4A is a schematic sectional view, and FIG. 4B is a plan view of the laser unit 20. In the light source device according to this embodiment, the laser unit 20 includes the laser devices 21, the lenses 22, and a laser holder 23. The wavelength converter 30 includes the heat dissipator 31, the phosphor layer 32, and a reflector 34.

In this embodiment, as illustrated in FIGS. 4A and 4B, the plurality of laser devices 21 are held by the laser holder 23, and the primary lights L1 from the laser devices 21 are applied to the phosphor layer 32 through the plurality of lenses 22 in one-to-one relation. A diameter of the laser holder 23 is substantially comparable to the inner diameter of the light input portion of the heat dissipator 31.

The laser unit 20 is arranged at one end of the heat dissipator 31, and the reflector 34 for reflecting the primary light L1 and the secondary light L2 is arranged at the other end. The heat dissipator 31 has a substantially uniform circular cylindrical shape or a circular cylindrical shape with an inner diameter slightly decreasing toward the reflector 34. The primary light L1 from each of the laser devices 21 in the laser unit 20 is controlled by the lens 22 and is applied to the phosphor layer 32 over the entire length of the heat dissipator 31. In this embodiment, therefore, a region extending along the phosphor layer 32 and illuminated with the primary light L1 from each laser device 21 becomes the illuminated region.

In the light source device according to this embodiment illustrated in FIGS. 4A and 4B, the primary lights L1 emitted from the laser unit 20 are applied to the illuminated regions along a lengthwise direction of the phosphor layer 32, and are partly wavelength-converted to the secondary lights L2. Furthermore, the primary light L1 having not been subjected to the wavelength conversion and the secondary light L2 are reflected by the inner surface of the heat dissipator 31 and the phosphor layer 32, and are further reflected by the reflector 34 to be output to the outside for illumination from the side where the laser unit 20 is arranged. Thus, in this embodiment, the light input portion and the light output portion are positioned on the same side, and an area of the light output portion of the wavelength converter 30 is the same as that of the light input portion.

Also in this embodiment, a direction of a normal line to a principal surface of each illuminated region of the phosphor layer 32 is different from an outgoing direction of white light from the light output portion, and those directions are substantially perpendicular to each other. Thus, by separately setting the illuminated region where the primary light L1 is wavelength-converted to the secondary light L2 and the light output portion from each other, the area of the light output portion can be reduced while the area of the illuminated region can be enlarged and a larger quantity of light can be emitted.

Furthermore, since the primary lights L1 are applied to the phosphor layer 32 by using the plurality of laser devices 21, an area of a region of the phosphor layer 32 in the wavelength converter 30 to which the primary light L1 is not applied can be reduced, and the total area of the illuminated regions can be increased. Thus, the illuminated regions can be distributed over the entirety of the phosphor layer 32, and heat dissipation performance can be improved.

Also with this embodiment, since the area of each illuminated region of the phosphor layer 32 is set to be larger than that of the light output portion, heat generated in the illuminated region with the wavelength conversion is effectively transmitted to the heat dissipator 31 and dissipated to the outside of the light source device. Accordingly, even when a quantity of the primary light L1 emitted from each laser device 21 is increased, a temperature rise in the illuminated region of the phosphor layer 32 can be suppressed, and deterioration and damage of the phosphor layer 32 can be avoided. Furthermore, since the white light is taken out from the light output portion having the cross-sectional area of not larger than 7 mm², a high luminance of not lower than 1000 Mcd/m² can be obtained. As a result, a higher luminance and a smaller size can be realized while the structure is simplified without using a rotation mechanism.

### Third Embodiment

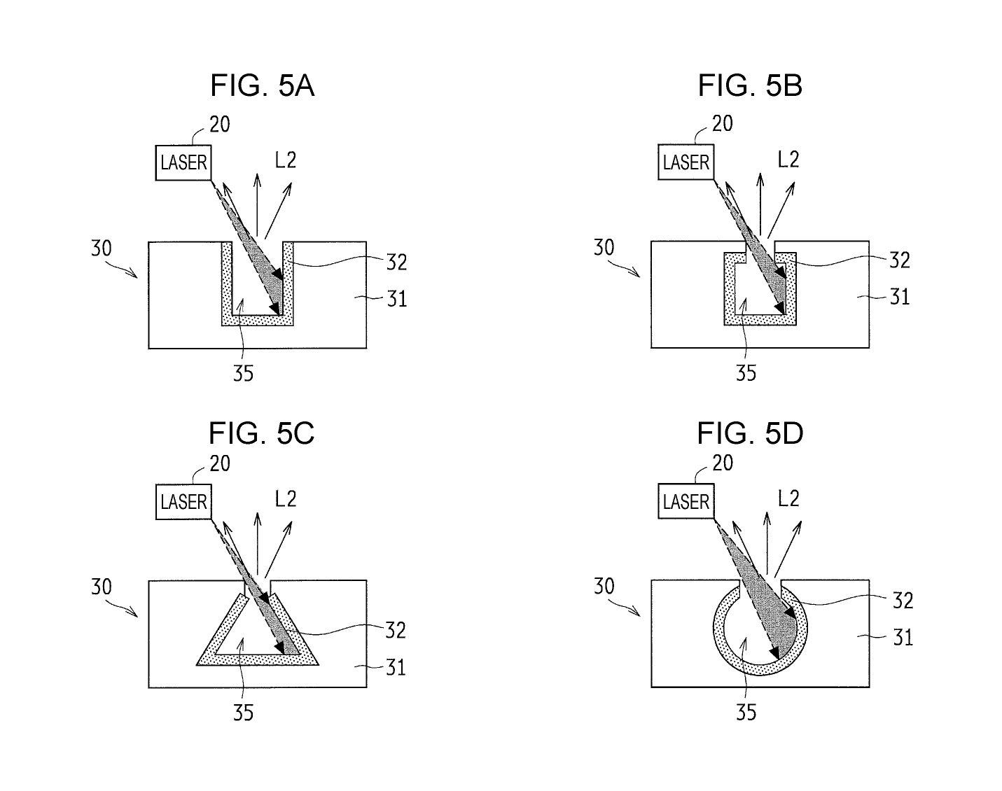

A third embodiment of the present disclosure will be described below with reference to the drawings. Description of components similar to those in the first embodiment is omitted. FIGS. 5A, 5B, 5C and 5D illustrate a light source device according to this embodiment; specifically, FIG. 5A represents an example in which the phosphor layer 32 is formed on an inner surface of a recess 35 in the heat dissipator 31, FIG. 5B represents an example in which the area of the light output portion is reduced, FIG. 5C represents an example in which the recess has a wide bottom, and FIG. 5D represents an example in which the recess has a substantially spherical shape. In the light source device according to this embodiment, the wavelength converter 30 includes the heat dissipator 31, the phosphor layer 32, and the recess 35.

In this embodiment, as illustrated in FIGS. 5A, 5B, 5C and 5D, the heat dissipator 31 is constituted by a metal member having a massive body, the recess 35 is formed by hollowing out part of the massive body, and the phosphor layer 32 is formed on the inner surface of the recess 35. The inner surface of the recess 35 is constituted as a reflective surface reflecting both the primary light L1 and the secondary light L2 as in the first embodiment. With the light source device according to this embodiment, as illustrated in FIGS. 5A, 5B, 5C and 5D, since the metal member having the massive body is used as the heat dissipator 31, the heat capacity of the heat dissipator 31 is increased, and heat generated in the phosphor layer 32 can be effectively transmitted and dissipated to the outside.

In the light source device according to this embodiment, the primary light L1 from the laser unit 20 is applied to the illuminated region of the phosphor layer 32 through an opening of the recess 35, and is partly wavelength-converted to the secondary light L2. The primary light L1 having not been subjected to the wavelength conversion and the secondary light L2 are reflected by the inner surface of the recess 35, and are taken out as white light through the opening of the recess 35. Thus, an opening area of the recess 35 is given as the area of the light output portion in this embodiment.

In the example illustrated in FIG. 5A, because an inner diameter of the recess 35 is constant, the area of the light output portion is substantially the same as a cross-sectional area of the recess 35 in which the phosphor layer 32 is formed. In the examples illustrated in FIGS. 5B to 5D, because the area of the light output portion of the recess 35 can be made smaller than a cross-sectional area of a portion of the recess 35 in which the phosphor layer 32 is formed, those examples are suitable for obtaining a higher luminance.

Also with this embodiment, since the area of the illuminated region of the phosphor layer 32 is set to be larger than that of the light output portion, heat generated in the illuminated region with the wavelength conversion is effectively transmitted to the heat dissipator 31 and dissipated to the outside of the light source device. Accordingly, even when a quantity of the primary light L1 emitted from the laser device 21 is increased, a temperature rise in the illuminated region of the phosphor layer 32 can be suppressed, and deterioration and damage of the phosphor layer 32 can be avoided. Furthermore, since the white light is taken out from the light output portion having the cross-sectional area of not larger than 7 mm², a high luminance of not lower than 1000 Mcd/m² can be obtained. As a result, a higher luminance and a smaller size can be realized while the structure is simplified without using a rotation mechanism.

### Fourth Embodiment

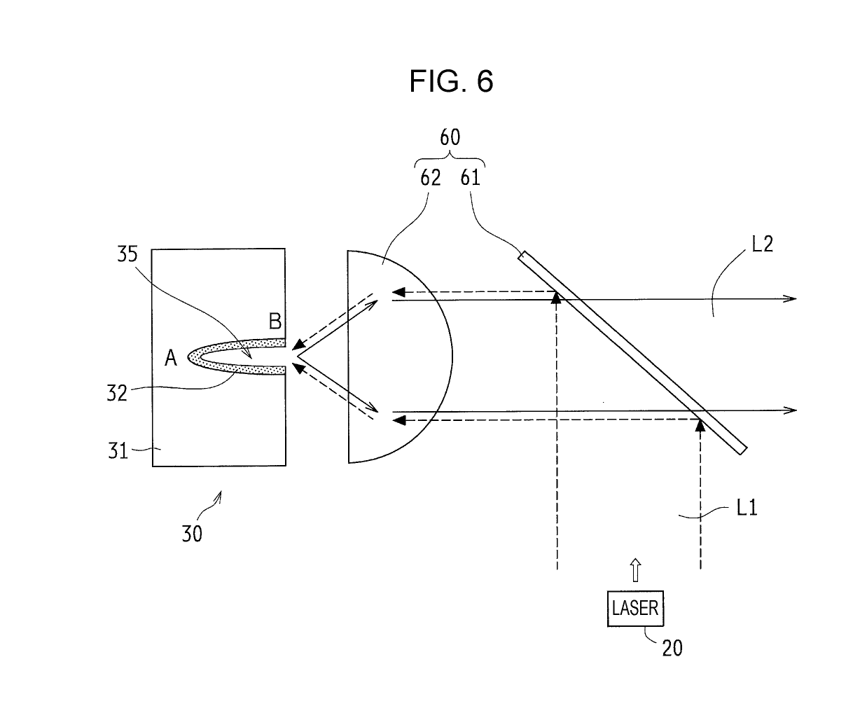

A fourth embodiment of the present disclosure will be described below with reference to the drawing. Description of components similar to those in the first embodiment is omitted. FIG. 6 is a schematic sectional view illustrating a light source device according to this embodiment. The light source device according to this embodiment includes the laser unit 20, the wavelength converter 30, and a monochrome separation/synthesis unit 60. The wavelength converter 30 includes the heat dissipator 31, the phosphor layer 32, and the recess 35. The monochrome separation/synthesis unit 60 includes a dichroic mirror 61 and a lens 62.

This embodiment represents an example in which the light source device is applied to a projector apparatus. Blue light of a wavelength of about 450 nm is emitted as the primary light L1 from the laser unit 20, and a cerium-doped lutetium aluminum garnet (LuAG:Ce)-based green phosphor is used as a material of the phosphor particles contained in the phosphor layer 32.

The dichroic mirror 61 is an optical member for reflecting light of a predetermined wavelength, and allowing light of another wavelength to pass therethrough. In this embodiment, the dichroic mirror 61 is designed to provide wavelength characteristics of reflecting the blue light as the primary light L1, but allowing green light as the secondary light L2 to pass therethrough. The lens 62 is an optical member for focusing parallel light into a focal position, and for converting light from the focal position to parallel light. A known condensing lens can be used as the lens 62.

In this embodiment, the primary light L1 emitted from the laser unit 20 is reflected by the dichroic mirror 61, and is applied to the phosphor layer 32 in the recess 35 through the lens 62. Part of the primary light L1 is wavelength-converted to the secondary light L2 in the illuminated region of the phosphor layer 32, and the primary light L1 having not been subjected to the wavelength conversion and the secondary light L2 reach the lens 62 from the light output portion through the opening of the recess 35. The primary light L1 and the secondary light L2 taken out from the light output portion is controlled by the lens 62 such that only the secondary light L2 passes through the dichroic mirror 61 and is output to the outside for illumination.

In the projector apparatus, a blue laser and a red laser are prepared in addition to the light source device illustrated in FIG. 6, and image projection toward the outside is performed through the projection optical system 50 by alternately illuminating the image display device 70, such as a DMD, with parallel lights of red, green and blue.

In the light source device illustrated in FIG. 6, the phosphor layer 32 is formed in the recess 35 having a diameter of about 2.5 mm and formed in the heat dissipator 31 made of aluminum in the shape of a massive body, for example. The focal position of the lens 62 is designed to be set at a center of an output opening B of the recess 35. Accordingly, the primary light L1 from the laser unit 20 is uniformly applied to the entirety of the phosphor layer 32 on the inner surface of the recess 35, and the wavelength conversion can be performed with use of the illuminated region having a large area.

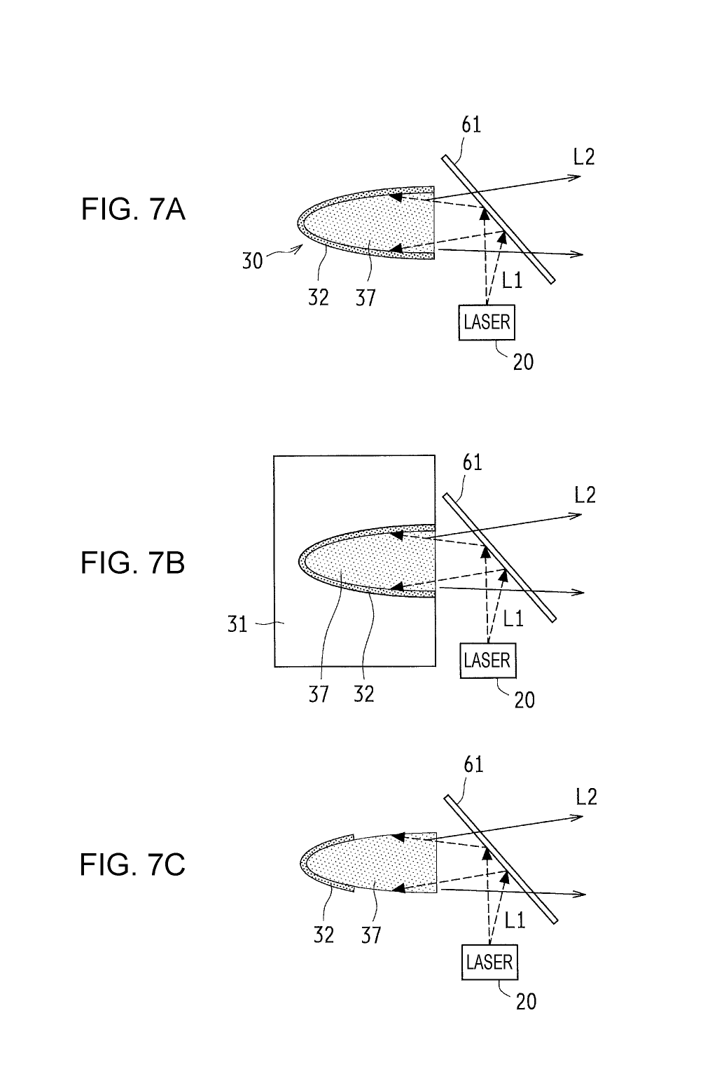

FIGS. 7A, 7B and 7C are schematic sectional views illustrating modifications of this embodiment; specifically, FIG. 7A represents an example in which the phosphor layer is formed on a surface of a transparent member 37, FIG. 7B represents an example in which the phosphor layer is formed on the inner surface of the recess in the heat dissipator 31 and the transparent member is filled in the recess, and FIG. 7C represents an example in which the phosphor layer is formed on a surface of part of the transparent member. As illustrated in FIGS. 7A, 7B and 7C, the light source device according to each of these modifications includes the laser unit 20, the wavelength converter 30, and the dichroic mirror 61. The wavelength converter 30 includes the transparent member 37.

The transparent member 37 is a cannonball-shaped member having a substantially parabolic external surface, and is made of a material allowing both the primary light L1 and the secondary light L2 to pass therethrough. The material used in practical applications is not limited to particular one, and glass or sapphire, for example, can be used. Sapphire is more advantageous because of having optical transparency and thermal conductivity. The phosphor layer 32 is formed on the substantially parabolic external peripheral surface of the transparent member 37, but the phosphor layer 32 is not formed on a substantially circular opened cross-section of the transparent member 37, the cross-section facing the dichroic mirror 61. The opened cross-section of the transparent member 37 has a substantially circular shape with a diameter of about 3 mm, for example, and light is input and output through the opened cross-section. Thus, the opened cross-section of the transparent member 37 serves not only as the light input portion, but also as the light output portion.

This modification represents an example in which the light source device is applied to the illumination apparatus. Near-ultraviolet light having a wavelength of about 405 nm and exhibiting low visual sensitivity is emitted as the primary light L1 from the laser unit 20, and a mixture of plural types of phosphor particles excited by the near-ultraviolet light and emitting red, green and blue lights as the secondary lights L2 is used to form the phosphor layer 32. Taking into account the above, the dichroic mirror 61 is designed to have wavelength characteristics of reflecting the near-ultraviolet light and allowing visible light to pass therethrough.

In this modification, the primary light L1 from the laser unit 20 enters the transparent member 37 after having been reflected by the dichroic mirror 61, and uniformly impinges upon the entirety of the phosphor layer 32 that is formed on the surface of a curved portion of the transparent member 37. Part of the primary light L1 incident upon the illuminated region of the phosphor layer 32 is wavelength-converted to the secondary light L2, and the primary light L1 having not been subjected to the wavelength conversion and the secondary light L2 reach the dichroic mirror 61 through the opened cross-section of the transparent member 37. Because the dichroic mirror 61 reflects the primary light L1, white light resulting from mixing of the secondary lights L2 in red, green and blue is taken out to the outside.

In the modifications illustrated in FIGS. 7A and 7C, since the phosphor layer 32 is formed on the surface of the transparent member 37, heat generated in the illuminated region with the wavelength conversion is effectively transmitted to the transparent member 37 and dissipated to the outside of the light source device. In the modification illustrated in FIG. 7C, since the phosphor layer 32 is formed on only a partial region of the transparent member 37, heat dissipation characteristics of the entire wavelength converter 30 can be optimized in consideration of a balance between the heat quantity generated in the phosphor layer 32 with the wavelength conversion and the heat capacity based on the volume of the transparent member 37.

In the modification illustrated in FIG. 7B, the recess 35 is formed in the heat dissipator 31 in the shape of a massive body, the phosphor layer 32 is formed on an inner surface of the recess 35, and the transparent member 37 is filled in an inner space defined by the phosphor layer 32. The inner surface of the recess 35 is constituted as a reflective surface reflecting the primary light L1 and the secondary light L2 as in the first embodiment. Therefore, heat generated in the phosphor layer 32 is effectively transmitted and dissipated to the outside through the heat dissipator 31 and the transparent member 37. In any of the modifications illustrated in FIGS. 7A, 7B and 7C, the transparent member 37 is disposed in contact with the phosphor layer 32 on one side in a film-thickness direction thereof, the one side being illuminated with the primary light L1, and the transparent member 37 functions as a heatsink. Thus, the heat generated in the phosphor layer 32 with the wavelength conversion can be more efficiently transmitted and dissipated to the outside.

Also with this embodiment, since the area of the illuminated region of the phosphor layer 32 is set to be larger than that of the light output portion, the heat generated in the illuminated region with the wavelength conversion is effectively transmitted to the transparent member 37 and dissipated to the outside of the light source device. Accordingly, even when a quantity of the primary light L1 emitted from the laser device 21 is increased, a temperature rise in the illuminated region of the phosphor layer 32 can be suppressed, and deterioration and damage of the phosphor layer 32 can be avoided. Furthermore, since the white light is taken out from the light output portion having the cross-sectional area of not larger than 7 mm², a high luminance of not lower than 1000 Mcd/m² can be obtained. As a result, a higher luminance and a smaller size can be realized while the structure is simplified without using a rotation mechanism.

### Fifth Embodiment

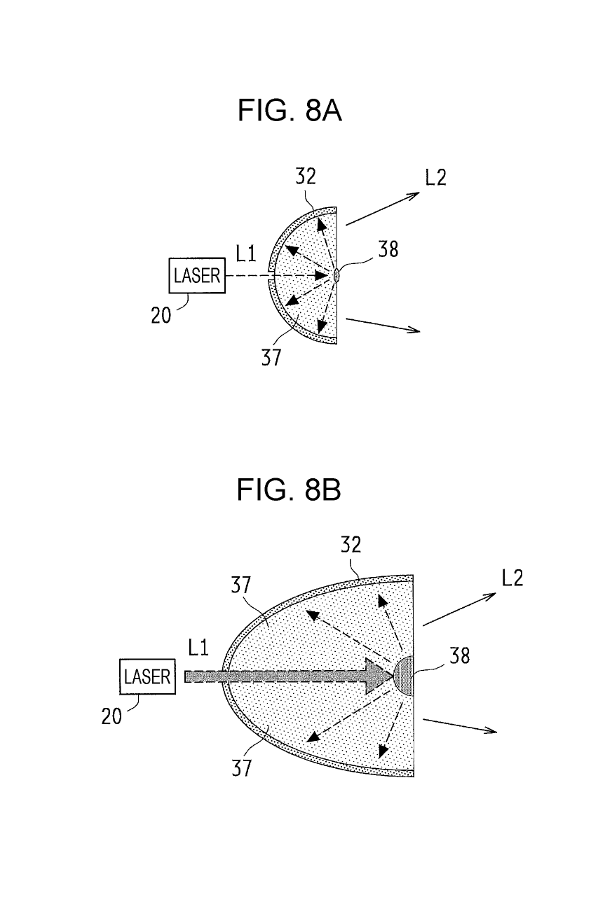

A fifth embodiment of the present disclosure will be described below with reference to the drawings. Description of components similar to those in the first embodiment is omitted. FIGS. 8A and 8B are schematic sectional views each illustrating a light source device according to this embodiment; specifically, FIG. 8A represents an example in which the wavelength converter has a substantially semispherical shape, and FIG. 8B represents an example in which the wavelength converter has a substantially parabolic shape. The light source device according to this embodiment includes the laser unit 20 and the wavelength converter 30. The wavelength converter 30 includes the phosphor layer 32, the transparent member 37, and a scatterer 38.

The scatterer 38 is arranged substantially at the center of an opened cross-section of the transparent member 37, and scatters the primary light L1. Although the shape of the scatterer 38 is not limited to particular one, it is advantageous that the scatterer 38 has a substantially semispherical dome shape for the purpose of uniformly illuminating the phosphor layer 32 with the primary light L1. It is also advantageous that a substantially semispherical surface of the scatterer 38 is a scattering surface in which fine irregularities are formed. The material of the scatterer 38 is not limited to particular one, and it may be a metal having a high reflectance. For instance, the scatterer 38 may be constituted by forming a recess in the transparent member 37, and by forming a metal film having a high reflectance, such as an aluminum film, on an inner surface of the recess.

In this embodiment, as illustrated in FIGS. 8A and 8B, the phosphor layer 32 is formed over an almost entire curved surface of the substantially semispherical or parabolic transparent member 37 except for the apex. Furthermore, the transparent member 37 has a substantially flat opened cross-section on the side opposite to the laser unit 20, and the scatterer 38 is arranged at the center of the opened cross-section.

The primary light L1 from the laser unit 20 is applied to the transparent member 37 through a zone of the apex where the phosphor layer 32 is not formed, and is scattered by the scatterer 38 such that the almost entire surface of the phosphor layer 32 is uniformly illuminated with the primary light L1. In the illuminated region of the phosphor layer 32 under illumination with the primary light L1, part of the primary light L1 is wavelength-converted to the secondary light L2, and the primary light L1 having not been subjected to the wavelength conversion and the secondary light L2 are taken out to the outside through the opened cross-section of the transparent member 37. Thus, the opened cross-section of the transparent member 37 corresponds to the light output portion. Moreover, since the phosphor layer 32 is illuminated with the primary light L1 after having been uniformly scattered by the scatterer 38, the almost entire surface of the phosphor layer 32 is able to function as the illuminated region.

Also with this embodiment, since the area of the illuminated region of the phosphor layer 32 is set to be larger than that of the light output portion and the primary light L1 is uniformly applied to the illuminated region, local generation of heat in the phosphor layer 32 can be suppressed. The heat generated in the illuminated region with the wavelength conversion is effectively transmitted to the transparent member 37 and dissipated to the outside of the light source device. Accordingly, even when a quantity of the primary light L1 emitted from the laser device 21 is increased, a temperature rise in the illuminated region of the phosphor layer 32 can be suppressed, and deterioration and damage of the phosphor layer 32 can be avoided. Furthermore, since the white light is taken out from the light output portion having the cross-sectional area of not larger than 7 mm², a high luminance of not lower than 1000 Mcd/m² can be obtained. As a result, a higher luminance and a smaller size can be realized while the structure is simplified without using a rotation mechanism.

### Sixth Embodiment

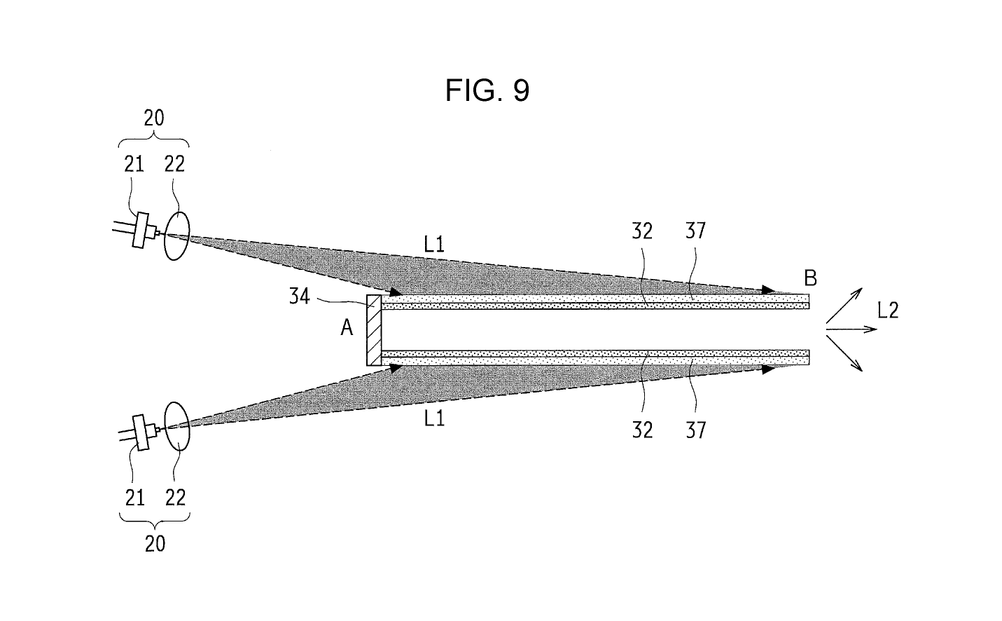

A sixth embodiment of the present disclosure will be described below with reference to the drawing. Description of components similar to those in the first embodiment is omitted. FIG. 9 is a schematic sectional view illustrating a structure of the light source device according to this embodiment. In the light source device according to this embodiment, the laser unit 20 includes the laser device 21 and the lens 22. The wavelength converter 30 includes the phosphor layer 32, the reflector 34, and the transparent member 37.

In this embodiment, as illustrated in FIG. 9, the transparent member 37 has a substantially circular cylindrical shape. The reflector 34 is arranged at one end A of the transparent member 37, and the other end of the transparent member 37 is used as the light output portion B. The phosphor layer 32 is formed on an inner surface of the transparent member 37. The phosphor layer 32 may be formed on an inner surface of the reflector 34 as well.

In the light source device according to this embodiment illustrated in FIG. 9, a beam size of the primary light L1 emitted from the laser device 21 is enlarged through the lens 22 and is almost uniformly applied to the phosphor layer 32 after passing through the transparent member 37. At that time, optical axes of both the laser device 21 and the primary light L1 are inclined relative to a central axis of the substantially circular cylindrical shape of the transparent member 37, and the primary light L1 is applied to a wide region of the phosphor layer 32 formed on the inner surface of the transparent member 37. Assuming that a region of the phosphor layer 32 to which the primary light L1 is directly applied from the laser device 21 is called an “illuminated region”, the illuminated region spans over substantially an entire length of the inner surface of the transparent member 37 in one half of the substantially circular cylindrical shape.

A dielectric multilayer film filter allowing only the primary light L1 to pass therethrough and reflecting the secondary light L2 may be disposed between the transparent member 37 and the phosphor layer 32. The primary light L1 applied from the outside of the transparent member 37 is applied to the phosphor layer 32 after passing through both the transparent member 37 and the dielectric multilayer film filter, while the secondary light L2 having been wavelength-converted in the illuminated region of the phosphor layer 32 is reflected by the dielectric multilayer film filter. Accordingly, the secondary light L2 having been wavelength-converted in the illuminated region of the phosphor layer 32 is avoided from leaking to the outside through the transparent member 37. In other words, the secondary light L2 is repeatedly reflected in the substantially circular cylindrical transparent member 37 and is effectively taken out from the light output portion B. Hence the light output efficiency can be increased.

Part of the primary light L1 is wavelength-converted to the secondary light L2 in the illuminated region of the phosphor layer 32, and the primary light L1 having not been subjected to the wavelength conversion and the secondary light L2 are output to the outside for illumination from the light output portion B after having been reflected by the inner surface of the transparent member 37 and the phosphor layer 32. In an example, by using, as the primary light L1, blue light of a wavelength of about 450 nm, and by using, as the phosphor layer 32, a YAG-based yellow phosphor, white light resulting from color mixing of the primary light L1 and the secondary light L2 can be applied for illumination. In another example, by using, as the primary light L1, near-ultraviolet light of a wavelength of about 405 nm, and by using, as the phosphor layer 32, a mixture of red, green and blue phosphors, white light resulting from color mixing of the primary light L1 and the secondary light L2 can be applied for illumination.

Also with this embodiment, the transparent member 37 is disposed in contact with the phosphor layer 32 on one side in a film-thickness direction thereof, the one side being illuminated with the primary light L1, and the transparent member 37 functions as a heatsink. Therefore, the heat generated in the phosphor layer 32 with the wavelength conversion can be more efficiently transmitted and dissipated to the outside. Furthermore, since the area of the illuminated region of the phosphor layer 32 is set to be larger than that of the light output portion B, the heat generated in the illuminated region with the wavelength conversion is effectively transmitted to the transparent member 37 and dissipated to the outside of the light source device. Accordingly, even when a quantity of the primary light L1 emitted from the laser device 21 is increased, a temperature rise in the illuminated region of the phosphor layer 32 can be suppressed, and deterioration and damage of the phosphor layer 32 can be avoided. In addition, since the white light is taken out from the light output portion having the cross-sectional area of not larger than 7 mm², a high luminance of not lower than 1000 Mcd/m² can be obtained. As a result, a higher luminance and a smaller size can be realized while the structure is simplified without using a rotation mechanism.

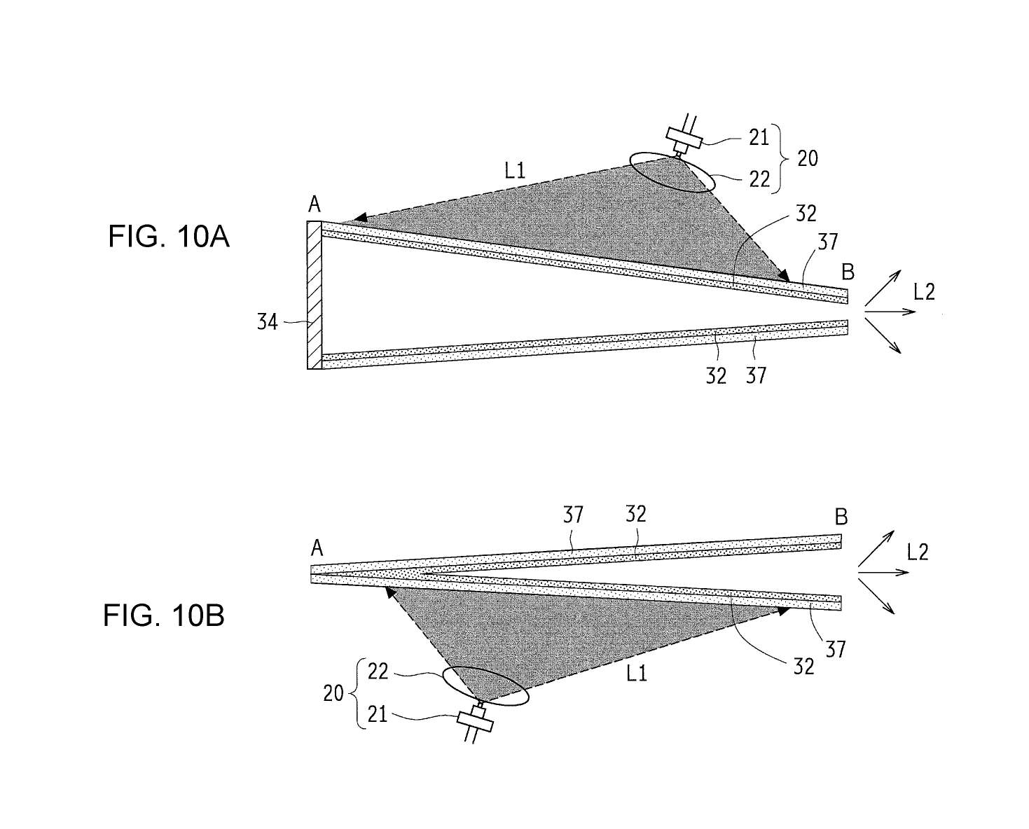

FIGS. 10A and 10B are schematic sectional views illustrating modifications of the sixth embodiment; specifically, FIG. 10A represents an example in which the wavelength converter has a substantially truncated cone shape with a smaller diameter on the side including the light output portion B, and FIG. 10B represents an example in which the wavelength converter has a substantially truncated cone shape with a larger diameter on the side including the light output portion B. As illustrated in FIGS. 10A and 10B, inner diameters of the transparent member 37 and the phosphor layer 32 may not be constant from the one end A to the light output portion B, and the wavelength converter may have a substantially truncated cone shape with an inner diameter gradually decreasing or increasing. In the modification illustrated in FIG. 10A, the luminance can be increased with the reduced cross-sectional area of the light output portion B. In the modification illustrated in FIG. 10B, since the inner diameter is gradually increased toward the light output portion B, the primary light L1 and the secondary light L2 can be effectively reflected to advance toward the light output portion B, and the light output efficiency can be increased.

The present disclosure contains subject matter related to that disclosed in Japanese Priority Patent Application JP 2018-030533 filed in the Japan Patent Office on Feb. 23, 2018, the entire contents of which are hereby incorporated by reference.

The embodiments disclosed here are merely illustrative in all respects, and are not to be regarded as providing any basis for limitative interpretation. Thus, the technical scope of the present disclosure is not to be interpreted on the basis of only the above-described embodiments, and is defined on the basis of the matters stated in the appended claims. It should be understood by those skilled in the art that various modifications, combinations, sub-combinations and alterations may occur depending on design requirements and other factors insofar as they are within the scope of the appended claims or the equivalents thereof.

What is claimed is:

1. A light source device comprising:
a laser device emitting primary light;
a wavelength converter including an illuminated region to which the primary light is applied, and performing wavelength conversion from the primary light to secondary light; and
a light output portion through which the secondary light is taken out,
wherein an area of the illuminated region is larger than an area of the light output portion, and
the area of the light output portion is not larger than 7 mm².

2. The light source device according to claim 1, wherein the primary light is applied to the illuminated region from the laser device while a beam size of the primary light is enlarged.

3. The light source device according to claim 1, wherein a direction of a normal line to a principal surface of the illuminated region is different from a principal direction in which the secondary light is output from the light output portion.

4. The light source device according to claim 3, wherein the direction of the normal line to the principal surface of the illuminated region is substantially perpendicular to the principal direction in which the secondary light is output from the light output portion.

5. The light source device according to claim 1, wherein the wavelength converter includes a phosphor layer formed in a state containing many phosphor particles that are substantially contacted with each other.

6. The light source device according to claim 1, wherein the primary light is uniformly applied to the illuminated region.

7. The light source device according to claim 6, wherein the primary light is applied to the illuminated region after having been diffused by a diffuser.

8. An illumination apparatus using the light source device according to claim 1.

9. A projector apparatus using the light source device according to claim 1.

10. A light source device comprising:
a laser device emitting primary light;
a wavelength converter including an illuminated region to which the primary light is applied, and performing wavelength conversion from the primary light to secondary light; and
a light output portion through which the secondary light is taken out,
wherein an area of the illuminated region is larger than an area of the light output portion, and
a luminance of the secondary light in the light output portion is not lower than 1000 Mcd/m².

11. The light source device according to claim 10, wherein the primary light is applied to the illuminated region from the laser device while a beam size of the primary light is enlarged.

12. The light source device according to claim 10, wherein a direction of a normal line to a principal surface of the illuminated region is different from a principal direction in which the secondary light is output from the light output portion.

13. The light source device according to claim 12, wherein the direction of the normal line to the principal surface of the illuminated region is substantially perpendicular to the principal direction in which the secondary light is output from the light output portion.

14. The light source device according to claim 10, wherein the wavelength converter includes a phosphor layer formed in a state containing many phosphor particles that are substantially contacted with each other.

15. The light source device according to claim 10, wherein the primary light is uniformly applied to the illuminated region.

16. The light source device according to claim 15, wherein the primary light is applied to the illuminated region after having been diffused by a diffuser.

17. An illumination apparatus using the light source device according to claim 10.

18. A projector apparatus using the light source device according to claim 10.
